(19) United States
(12) Patent Application Publication
(10) Pub. No.: US 2025/0060818 A1
(43) Pub. Date: Feb. 20, 2025

(54) CONTROLLER

(71) Applicant: HTC Corporation, Taoyuan City (TW)

(72) Inventors: Chang-Hua Wei, Taoyuan City (TW); Yu-Ling Huang, Taoyuan City (TW); Pei-Pin Huang, Taoyuan City (TW); Yen Chun Chen, Taoyuan City (TW); Tung-Ting Cheng, Taoyuan City (TW); Reinaldo Yang, Taoyuan City (TW); Chih-Ting Chen, Taoyuan City (TW)

(73) Assignee: HTC Corporation, Taoyuan City (TW)

(21) Appl. No.: 18/762,648

(22) Filed: Jul. 3, 2024

Related U.S. Application Data
(60) Provisional application No. 63/533,362, filed on Aug. 18, 2023.

(51) Int. Cl. G06F 3/01

(52) U.S. Cl. CPC G06F 3/014

(57) ABSTRACT

A controller includes a body and a surrounding part. The body has a control area for sending a control signal according to a movement of a thumb of a user. The surrounding part is connected to the body and used to surround and be fixed to a proximal phalange of an index finger of the user. The body is away from a joint between the proximal phalange and a metacarpal bone of the user.

### CROSS-REFERENCE TO RELATED APPLICATION

This application claims the priority benefit of U.S. provisional application Ser. No. 63/533,362, filed on Aug. 18, 2023. The entirety of the above-mentioned patent application is hereby incorporated by reference herein and made a part of this specification.

### FIELD OF THE INVENTION

The present application relates to a controller, and in particular to a controller fixed to a finger of a user.

### DESCRIPTION OF RELATED ART

Virtual Reality (VR) techniques are becoming more and more popular. In order to enhance the immersion during use, lightweight and simple controllers are also widely adopted, such as being worn on a finger of a user. FIG. 1 is a conventional controller. Referring to FIG. 1, a conventional controller 50 is made into a ring shape and is suitable for being worn on the proximal phalange of the index finger of the user, and the thumb of the user presses the controller 50 to send a control signal. However, the conventional controller 50 readily slides on the proximal phalange of the index finger of the user. When the controller 50 is located at a side of the proximal phalange of the index finger of the user close to the metacarpal bone, if the user presses the controller 50 with his thumb, he needs to bend his thumb unnaturally, and may readily feel fatigue and discomfort after long-term use.

### SUMMARY OF THE INVENTION

The present application provides a controller to solve the issue of difficulty in operation caused by a position of the controller.

A controller of the present application includes a body and a surrounding part. The body has a control area for sending a control signal according to a movement of a thumb of a user. The surrounding part is connected to the body and used to surround and be fixed to a proximal phalange of an index finger of the user. The body is away from a joint between the proximal phalange and a metacarpal bone of the user.

Based on the above, in the controller of the present application, the body is away from the joint between the proximal phalange and the metacarpal bone. Therefore, the thumb of the user may be in contact with and operate the body of the controller in a comfortable posture.

### BRIEF DESCRIPTION OF THE DRAWINGS

FIG. 1 is a schematic diagram of a conventional controller.

FIG. 2 is a schematic diagram of a controller of an embodiment of the invention.

FIG. 3 is a schematic diagram of the controller of FIG. 2 being worn on a hand of a user.

FIG. 4 is a schematic diagram of a disassembled state of a controller of another embodiment of the invention.

FIG. 5 is a schematic diagram of a disassembled state of a controller of another embodiment of the invention.

FIG. 6 is a schematic diagram of the controller of FIG. 5 being worn on a hand of a user after assembly.

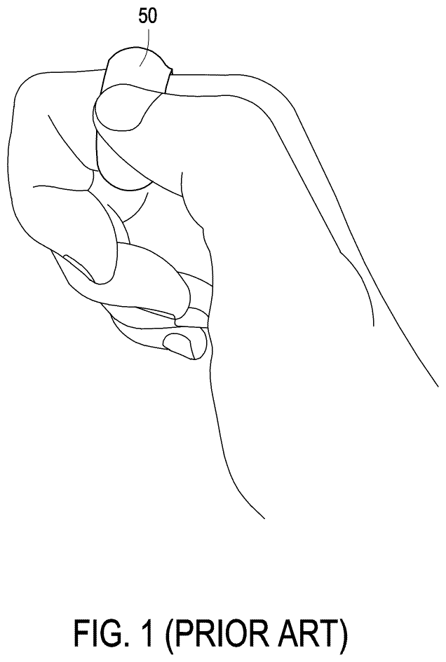

### DESCRIPTION OF THE EMBODIMENTS

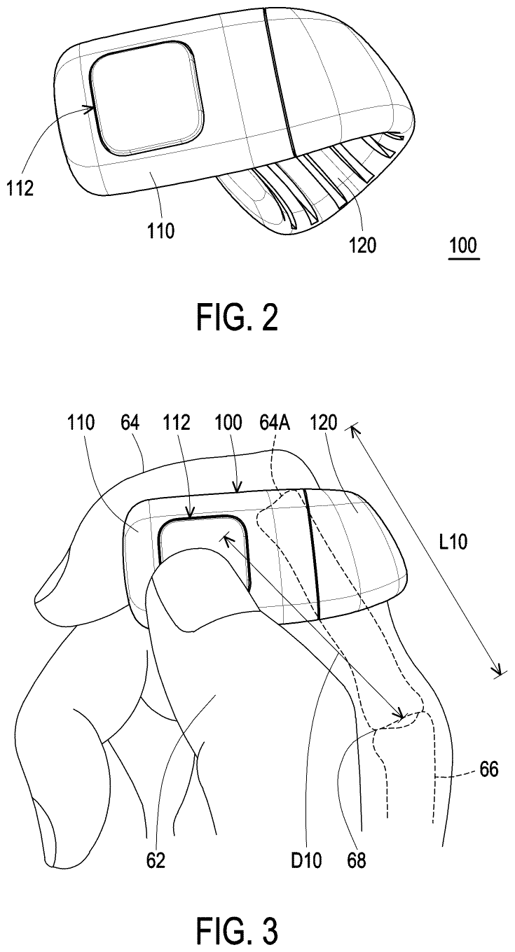

FIG. 2 is a schematic diagram of a controller of an embodiment of the invention. FIG. 3 is a schematic diagram of the controller of FIG. 2 being worn on a hand of a user. Referring to FIG. 2 and FIG. 3, a controller 100 of the present embodiment includes a body 110 and a surrounding part 120. The body 110 has a control area 112 for sending a control signal according to the movement of a thumb 62 of a user. The surrounding part 120 is connected to the body 110 and used to surround and be fixed to a proximal phalange 64A of an index finger 64 of the user. The body 110 is away from a joint 68 between the proximal phalange 64A and a metacarpal bone 66 of the user.

The controller 100 of the present embodiment includes the surrounding portion 120 and the body 110 connected to each other. With the arrangement of the surrounding part 120, the body 110 may be kept away from the joint 68 between the proximal phalange 64A and the metacarpal bone 66 of the user. That is, the thumb 62 of the user does not need to be bent excessively and may be in contact with the body 110 of the controller 100 in a comfortable posture. At the same time, a more natural way of operating the virtual reality interface with gestures is provided, which is suitable for the user to use the controller 100 for long periods of time.

In the present embodiment, a distance D10 between the body 110 and the joint 68 is greater than half a length L10 of the proximal phalange 64A. This ensures that the body 110 is kept away from the joint 68 between the proximal phalange 64A and the metacarpal bone 66 of the user.

In the present embodiment, the control area 112 is a touch area, which can, for example, sense the movement track, clicking, or other movements of the thumb 62 of the user in the control area 112.

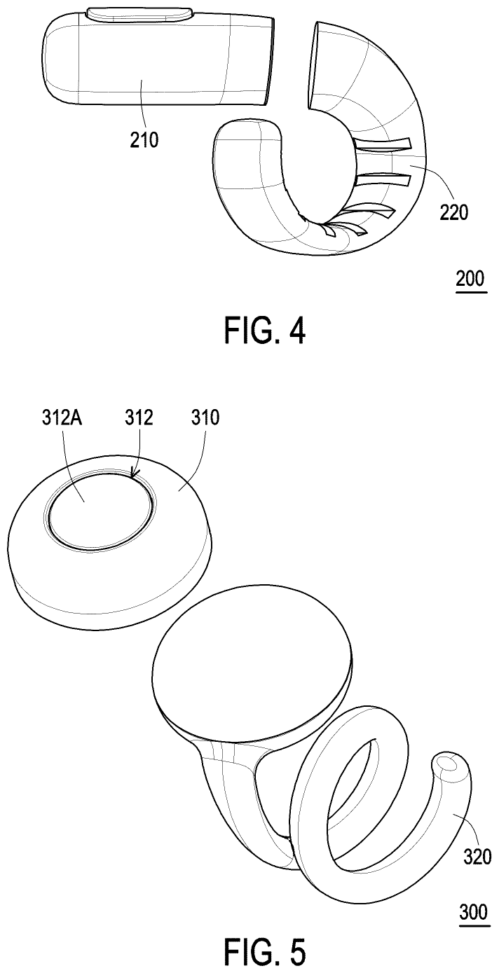

FIG. 4 is a schematic diagram of a disassembled state of a controller of another embodiment of the invention. Please refer to FIG. 4. A controller 200 of the present embodiment is substantially the same as the controller 100 of FIG. 2. The difference is that: the material of a surrounding part 220 may adopt an elastic material, and the elastic material may adapt to the finger sizes of different users, thus not only providing a certain tolerance for size differences, reducing the cost of a large number of molds needed in the product development process, but also improving wearing comfort and stability. In addition, the surrounding part 220 of the controller 200 of the present embodiment is detachably assembled to a body 210 of the controller 200. Therefore, a variety of different sizes of the surrounding part 220 may be provided, allowing the user to select the surrounding part 220 of a size that suits him or her, and then connect the surrounding part 220 to the body 210 for use, thus achieving better stability. Moreover, when the fixing force of the surrounding part 220 is weakened or damaged, the controller 200 may be continued to be used as long as the surrounding part 220 is replaced. The surrounding part 120 of the controller 100 of FIG. 2 may also be detachably connected to the body 110. For example, the body 210 of the present embodiment may be assembled to the surrounding part 220 via a buckle, magnetic attraction, etc.

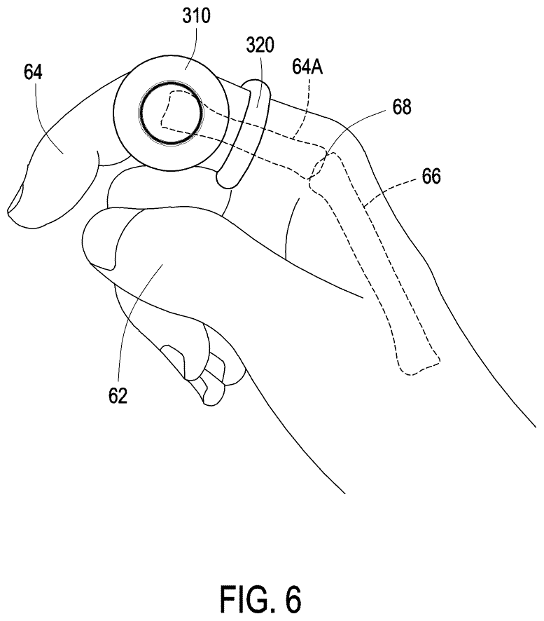

FIG. 5 is a schematic diagram of a disassembled state of a controller of another embodiment of the invention. FIG. 6 is a schematic diagram of the controller of FIG. 5 being worn on a hand of a user after assembly. Referring to FIG. 5 and FIG. 6, a controller 300 of the present embodiment is substantially the same as the controller 100 of FIG. 2, except that a surrounding part 320 is spring-shaped. Therefore, the surrounding part 320 may be firmly fixed on the proximal phalange 64A of the index finger 64 of the user, thus increasing the friction between the surrounding part 320 and the index finger 64 and reducing the possibility of the controller 300 accidentally falling off during operation.

In the present embodiment, a control area 312 of a body 310 has a physical button 312A. The thumb 62 of the user may press the physical button 312A to send a control signal. The physical button 312A may also have a touch function.

The surrounding part 320 of the controller 300 of the present embodiment may also be detachably assembled to the body 310. Therefore, the user may choose the surrounding part 320 of a size that suits him or her, thereby improving the stability and being replaceable. For example, the surrounding part 320 is magnetically attracted or buckled to the body 310, or connected using other mechanisms not shown.

Based on the above, in the controller of the present application, the surrounding part is connected to the body and kept away from the joint between the proximal phalange and the metacarpal bone. Therefore, the thumb of the user may be in contact with and control the body of the controller in a comfortable posture, providing a more natural way to operate the virtual reality interface with gestures, and is suitable for the user to use the controller for long periods of time.

What is claimed is:

1. A controller, comprising:
a body having a control area for sending a control signal according to a movement of a thumb of a user; and
a surrounding part connected to the body and used to surround and be fixed to a proximal phalange of an index finger of the user, and the body is away from a joint between the proximal phalange and a metacarpal bone of the user.

2. The controller of claim 1, wherein a distance between the body and the joint is greater than half a length of the proximal phalange.

3. The controller of claim 1, wherein a material of the surrounding part is an elastic material.

4. The controller of claim 1, wherein the surrounding part is spring-shaped.

5. The controller of claim 1, wherein the control area has a physical button.

6. The controller of claim 1, wherein the control area is a touch area.

7. The controller of claim 1, wherein the surrounding part is detachably assembled to the body.
